(19) United States
(12) Patent Application Publication
(10) Pub. No.: US 2017/0335523 A1
(43) Pub. Date: Nov. 23, 2017

(54) Snow Melting Apparatus

(71) Applicant: Abdulwahab Moussa, Valparaiso, IN (US)

(72) Inventor: Abdulwahab Moussa, Valparaiso, IN (US)

(21) Appl. No.: 15/484,110

(22) Filed: Apr. 10, 2017

Related U.S. Application Data
(60) Provisional application No. 62/319,985, filed on Apr. 8, 2016.

(51) Int. Cl. E01C 11/26; H05B 3/28

(52) U.S. Cl. CPC E01C 11/265; H05B 3/286; H05B 2203/015; H05B 2203/002

(57) ABSTRACT

A snow melting apparatus for melting snow on sidewalks, driveways, and other walkways is provided. The snow melting apparatus comprises a plurality of individual heating cables with the heat cables woven together to form a mesh-like covering mat and the covering mat having a top surface and a bottom surface. An outer perimeter border surrounds the covering mat. A snowfall sensor mechanism is mounted to the covering mat with the snowfall sensor mechanism detecting precipitation and automatically activating the heating cables. The top surface of the covering mat is presented for a person to walk and or stand while the bottom surface of the covering mat is capable of being positioned against the sidewalk, driveway, or other walkway. Upon activation of the heating cables, the temperature of the heating cables increases thereby heating the entire covering mat.

### CLAIM OF PRIORITY

This patent application claims priority under 35 USC 119 (e) (1) from U.S. Provisional Patent Application Ser. No. 62/319,985 filed Apr. 8, 2016, of common inventorship herewith entitled, “Snow Solution,” which is incorporated herein by reference as though the same were set forth in its entirety.

### FIELD OF THE INVENTION

The present invention pertains to the field of snow melting apparatuses, and more specifically to the field of snow melting apparatuses to providing is a sensor activated, electrically heated, grid covering mat for melting snow that is particularly constructed for sidewalks, driveways and other walkways.

### BACKGROUND OF THE INVENTION

During the winter months, many people are found outside their home or apartment, laboriously wielding a snow shovel to remove snow from their driveways and walkways. The city sends a truck to shovel the streets and drop salt on icy areas, but individuals still must clear areas form their front door to the shoveled streets. The task of removing accumulated snow from sidewalks, walkways and driveways is accomplished by hard manual labor, using a snow shovel to scoop up, lift and heave snow to the sides of walks and driveways. Businesses face the added task of making sure their office and storefront sidewalks afford traction for employees, pedestrians and customers to safeguard against individuals slipping and possibly being injured. Shoveling snow is a laborious job that has a potential to be injurious and dangerous, especially for those people who are older in age or physically unfit.

The prior art has put forth several designs for electrically heated mats for melting snow. Among these are:

U.S. Pat. No. 5,550,350 to Donald W. Barnes describes a device and method for melting ice and snow from walkways and steps. The device includes a rigid block of heat conducting plastic suitable for mounting on steps. An electrical heating element provides heat. The heat is distributed to the entire block and melts the snow or ice on the surface.

U.S. Pat. No. 4,967,057 to Ronald E. Bayless and James M. Havard describes individual electrically heated mats, self regulated by use of an electrical element whose resistance varies proportionately with its temperature, used for covering walking areas to prevent accumulation of snow and ice. Each mat is provided with male and female electrical connections on the ends of short power cords to permit any number of mats to be chained together in electrical parallel and used to cover, for example, a flight of stairs by positioning one mat on each stair.

U.S. Pat. No. 3,806,702 to D Spencer describes a weatherproof electrically insulative mat having an electrical heat producing conductor therein and adapted for placement on an exterior surface to prevent accumulation of snow on such surface. A control system for supplying current to the conductor including a precipitation sensor, a temperature sensor and a control unit responsive to the sensors so that power is supplied to the conductor in the mat only when there is precipitation and the temperature is below thirty five degrees. An improved mat structure that is approximately symmetrical of the central plane thereof so that when one side of the mat wears, the mat can be reversed.

None of these prior art references describe the present invention.

### SUMMARY OF THE INVENTION

It is an object of the present invention to provide is a snow melting apparatus having a sensor activated, heated, grid covering mat that is particularly constructed for sidewalks, driveways and other walkways.

The present invention is a snow melting apparatus for melting snow on sidewalks, driveways, and other walkways. The snow melting apparatus comprises a plurality of individual heating cables with the heat cables woven together to form a mesh-like covering mat and the covering mat having a top surface and a bottom surface. An outer perimeter border surrounds the covering mat. A snowfall sensor mechanism is mounted to the covering mat with the snowfall sensor mechanism detecting precipitation and automatically activating the heating cables. The top surface of the covering mat is presented for a person to walk and or stand while the bottom surface of the covering mat is capable of being positioned against the sidewalk, driveway, or other walkway. Upon activation of the heating cables, the temperature of the heating cables increases thereby heating the entire covering mat.

In addition, the present invention includes a method for melting snow on sidewalks, driveways, and other walkways. The method comprises providing a plurality of individual heating cables, weaving the heat cables together, forming a mesh-like covering mat with the covering mat having a top surface and a bottom surface, surrounding the covering mat with an outer perimeter edge, mounting a snowfall sensor mechanism, detecting precipitation with the snowfall sensor mechanism, automatically activating the heating cables, increasing the temperature of the heating cables, and heating the entire covering mat.

The present invention further includes a snow melting apparatus for melting snow on sidewalks, driveways, and other walkways. The snow melting apparatus comprises a plurality of individual heating cables with the heat cables woven together to form a mesh-like covering mat and the covering mat having a top surface and a bottom surface. An outer perimeter border completely surrounds the covering mat. A snowfall sensor mechanism is mounted to the top surface of the covering mat with the snowfall sensor mechanism detecting precipitation and automatically activating the heating cables. A power mechanism activates the heating cables. The top surface of the covering mat is presented for a person to walk and or stand while the bottom surface of the covering mat is capable of being positioned against the sidewalk, driveway, or other walkway. Upon activation of the heating cables, the temperature of the heating cables increases thereby heating the entire covering mat and upon detection of no precipitation by the snowfall sensor mechanism, the heating cables are deactivated.

### BRIEF DESCRIPTION OF THE DRAWINGS

FIG. 1 is a perspective view illustrating a snow melting apparatus, constructed in accordance with the present invention, showing a rectangular mat containing at least one snowfall sensor mechanism and an electrical cord for plugging into an outlet and providing power to the snow melting apparatus.

FIG. 2 is a perspective view illustrating the electrical sensor of the snow melting apparatus, constructed in accordance with the present invention, showing the snowfall sensor mechanism located in a corner of the mat such that when powered on, the snowfall sensor mechanism automatically detects falling snow and activates the snow melting apparatus to melt any accumulated the snow.

FIG. 3 is a perspective view illustrating a heating cable of the snow melting apparatus, constructed in accordance with the present invention.

FIG. 4 is a perspective view illustrating the electrical cord of the snow melting apparatus, constructed in accordance with the present invention, with an activation switch.

FIG. 5 is a top plan view illustrating the snow melting apparatus, constructed in accordance with the present invention, showing multiple-sized mats connectable to each other to cover any desired amount of area footage.

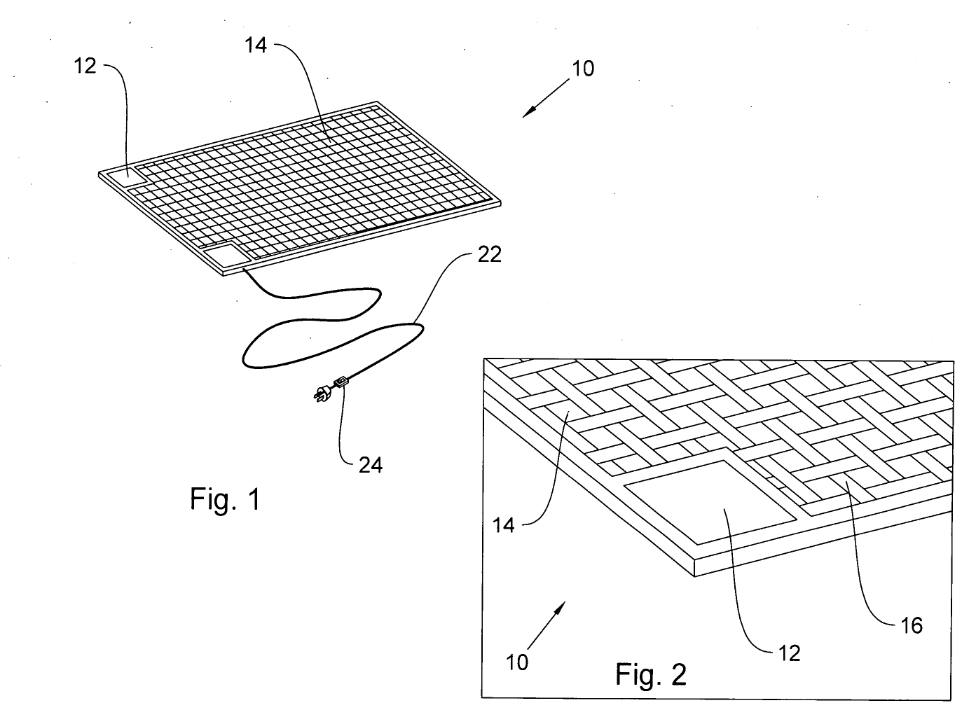

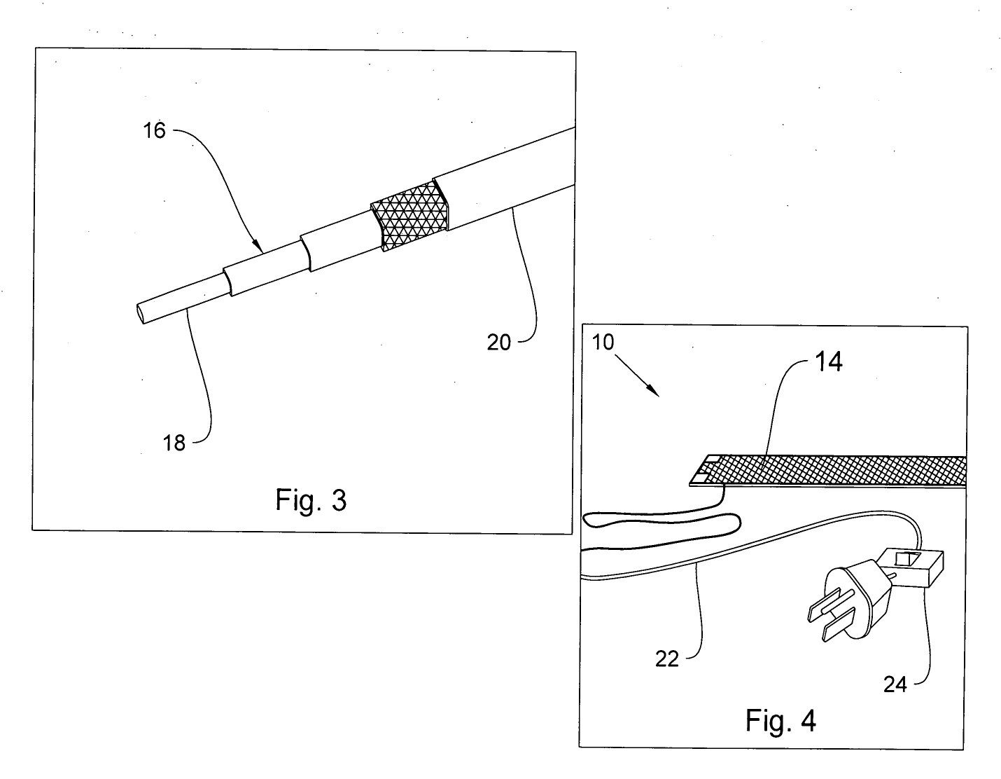

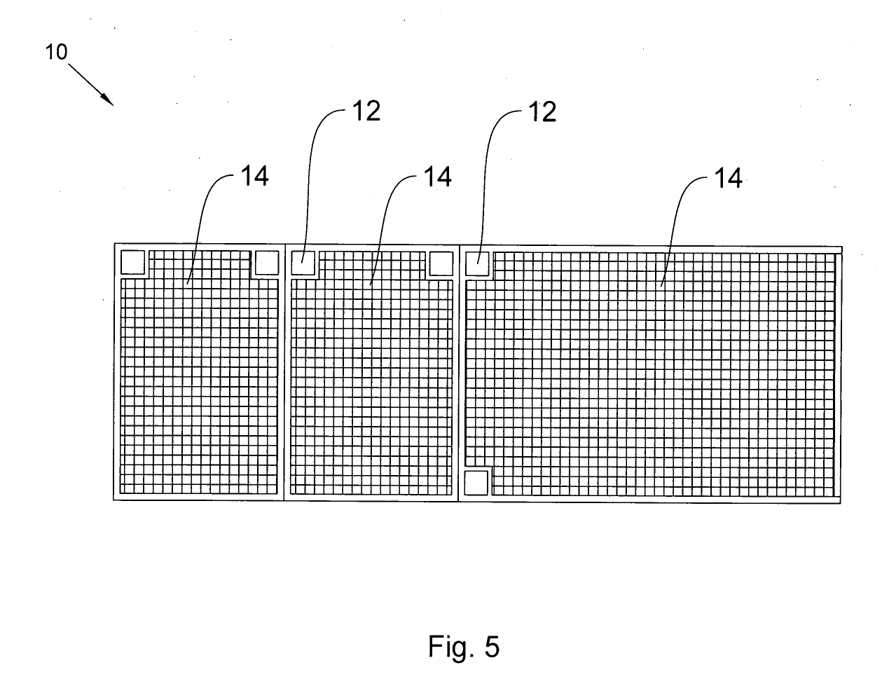

### DETAILED DESCRIPTION OF THE INVENTION

The present invention, hereinafter referred to as a Snow Melting Apparatus, indicated generally at 10, is a snowfall sensor mechanism 12 activated, heated, grid covering mat 14 particularly constructed for sidewalks, driveways, and other walkways. The Snow Melting Apparatus 10 provides a simple and effective means of preventing snow and ice accumulation in these areas. Using the Snow Melting Apparatus 10 eliminates any need to shovel, apply ground salt, or otherwise remove the snow manually.

The Snow Melting Apparatus 10 of the present invention includes a covering mat 14 having a top surface, a bottom surface, and an outer perimeter edge. The top surface of the covering mat 14 is presented for a person to walk and or stand while the bottom surface of the covering mat 14 is positioned against the ground, sidewalk, or driveway.

The covering mat 14 of the Snow Melting Apparatus is preferably constructed of a plurality of individual one-quarter (¼″) inch heat cables 16, woven together to form a mesh-like tarp with an open rectangular or triangular grid that is spreadable over various surface areas. Preferably, the grid configuration of the covering mat 14 provides openings between the woven heating cables 16 allowing water and debris to travel from the top surface of the covering mat 14 in a general direction toward the bottom surface of the covering mat 14.

Each of the heat cables 16 of the covering mat 14 of the Snow Melting Apparatus 10 of the present invention contains an internally contained insulated heating element, sensors, and thermostat. The heating cables 16 are configured as wires 18 surrounded and encased by at least one layer of a flexible, insulated plastic cover 20 that comprise the covering mat 14. The encased wires 18 are connected to each other in series or in parallel. As electricity passes through the encased wires 18, the resistance in the encased wires 18 increase the temperature of the heating cables 16 thus heating the entire covering mat 14.

The exterior of each heat cable 16 of the Snow Melting Apparatus 10 of the present invention is preferably manufactured of a slip resistant and weather resistant rubber or plastic material to inhibit falls and other accidents. The outer perimeter edge surrounds the heat cables 16 grid providing support and increased stability of the woven grid of heat cables 16. Preferably, the outer perimeter edge is constructed from a slip resistant and weather resistant material to assist in maintaining the covering mat 14 in a desired position.

Furthermore, the Snow Melting Apparatus 10 of the present invention is powered by means of AC electric power or battery with an integrated cord 22 that is connected to any outdoor power outlet. The electrical cord 22 can be provided with an activation switch 24 and wired to the heating cables 16 providing the necessary electricity to heat the encased wires 18. The activation switch 24 selectively turns the electricity to the encased wires 18 either on or off. The snow melting apparatus 10 can also be operated by means of rechargeable battery power for areas where there is no outdoor power outlet.

In addition, the Snow Melting Apparatus 10 of the present invention has an integrated snowfall sensor mechanism 12 that detects precipitation such as snow and sleet on contact, automatically activating the heating cables 16 of the covering mat 14. Preferably, the snowfall sensor mechanism 12 is positioned on the top surface of the covering mat 14, in one corner of the covering mat 14, however, positioning the snowfall sensor mechanism 12 at any position on the covering mat 14 is within the scope of the present invention. Once activated, the temperature of the insulated encased wires 18 quickly rises to warm the upper surface and the lower surface of the covering mat 14 and efficiently melt any accumulated ice or snow. When all ice and snow is eradicated and outdoor precipitation has ceased, the snowfall sensor mechanism 12 automatically powers off the Snow Melting Apparatus 10, saving electricity or battery power. After use, the covering mat 14 of the Snow Melting Apparatus 10 is removed from the designated surface, rolled into a tight coil, and conveniently stored away until needed again.

The covering mat of the Snow Melting Apparatus 10 of the present invention can be applied over existing ice or snow accumulation, melting frozen ice and snow on contact. The covering mat 14 is constructed in any size appropriate for a variety of uses. A residential driveway version, for example, measures approximately twelve (12′) feet in length by six (6′) feet in width. A larger commercial version for commercial establishments, for example, measures approximately two (2′) feet wide by twelve (12′) feet long, or longer for use on walkways. A size suitable for use on a residential front porch or step can be between one (1′) feet to two (2′) feet wide by two (2′) feet to four (4′) feet long. In addition to the aforementioned measurements, the Snow Melting Apparatus 10 can be manufactured in different lengths and widths to accommodate public and private sidewalks as well as long or short driveways and wide storefront sidewalks. Multiple covering mats 14 can be electrically and mechanically connected together to provide coverage for a larger area or unusually shaped area.

Using the Snow Melting Apparatus 10 of the present invention eliminates one of the most difficult and arduous tasks faced by people who live in snow prone areas. Senior citizens and individuals who suffer from limited physical capabilities no longer risk injury trying to shovel away snow or dealing with a hassle of handling heavy bags of salt. Durably constructed of high quality components and a nonskid surface, the Snow Melting Apparatus 10 will withstand many years of safe and continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A snow melting apparatus for melting snow on sidewalks, driveways, and other walkways, the snow melting apparatus comprising:
a plurality of individual heating cables, the heat cables woven together to form a mesh-like covering mat, the covering mat having a top surface and a bottom surface;
an outer perimeter border surrounding the covering mat; and
a snowfall sensor mechanism mounted to the covering mat, the snowfall sensor mechanism detecting precipitation and automatically activating the heating cables;
wherein the top surface of the covering mat is presented for a person to walk and or stand while the bottom surface of the covering mat is capable of being positioned against the sidewalk, driveway, or other walkway; and
wherein upon activation of the heating cables, the temperature of the heating cables increases thereby heating the entire covering mat.

2. The snow melting apparatus of claim 1 wherein each of the heat cables includes an internally contained insulated heating element, sensors, and thermostat.

3. The snow melting apparatus of claim 2 wherein the heating cables are wires surrounded and encased by at least one layer of a flexible, insulated plastic cover.

4. The snow melting apparatus of claim 3 wherein the cover of the heating cables are constructed from a slip resistant and weather resistant material for inhibiting falls.

5. The snow melting apparatus of claim 1 wherein the outer perimeter border completely surrounds the covering mat.

6. The snow melting apparatus of claim 1 wherein the outer perimeter border is constructed from a slip resistant and weather resistant material to assist in maintaining a relative position of the covering mat.

7. The snow melting apparatus of claim 1 wherein the heating cables are powered by AC electric power, and further comprising:
an electrical cord; and
an activation switch for selectively powering the heating cables.

8. The snow melting apparatus of claim 1 wherein the heating cables are powered by rechargeable battery power.

9. The snow melting apparatus of claim 1 wherein the snowfall sensor mechanism is positioned on the top surface of the covering mat, in one corner of the covering mat.

10. The snow melting apparatus of claim 1 wherein upon activation of the heating cables, both the top surface and the bottom surface of the covering mat are heated simultaneously.

11. The snow melting apparatus of claim 1 wherein upon detection of no precipitation by the snowfall sensor mechanism, the heating cables are deactivated.

12. The snow melting apparatus of claim 1 and further comprising:
openings between the woven heating cables allowing water and debris to travel from the top surface in a general direction toward the bottom surface.

13. The snow melting apparatus of claim 1 and further comprising:
multiple covering mats wired together.

14. A method for melting snow on sidewalks, driveways, and other walkways, the method comprising:
providing a plurality of individual heating cables;
weaving the heat cables together;
forming a mesh-like covering mat, the covering mat having a top surface and a bottom surface;
surrounding the covering mat with an outer perimeter edge;
mounting a snowfall sensor mechanism;
detecting precipitation with the snowfall sensor mechanism;
automatically activating the heating cables;
increasing the temperature of the heating cables; and
heating the entire covering mat.

15. A snow melting apparatus for melting snow on sidewalks, driveways, and other walkways, the snow melting apparatus comprising:
a plurality of individual heating cables, the heat cables woven together to form a mesh-like covering mat, the covering mat having a top surface and a bottom surface;
an outer perimeter border completely surrounding the covering mat;
a snowfall sensor mechanism mounted to the top surface of the covering mat, the snowfall sensor mechanism detecting precipitation and automatically activating the heating cables; and
power means for activating the heating cables;
wherein the top surface of the covering mat is presented for a person to walk and or stand while the bottom surface of the covering mat is capable of being positioned against the sidewalk, driveway, or other walkway;
wherein upon activation of the heating cables, the temperature of the heating cables increases thereby heating the entire covering mat; and
wherein upon detection of no precipitation by the snowfall sensor mechanism, the heating cables are deactivated.

16. The snow melting apparatus of claim 15 wherein the heating cables are wires surrounded and encased by at least one layer of a flexible, insulated plastic cover.

17. The snow melting apparatus of claim 15 wherein the cover of the heating cables are constructed from a slip resistant and weather resistant material for inhibiting falls and the outer perimeter border is constructed from a slip resistant and weather resistant material to assist in maintaining a relative position of the covering mat.

18. The snow melting apparatus of claim 15 wherein upon activation of the heating cables, both the top surface and the bottom surface of the covering mat are heated simultaneously.

19. The snow melting apparatus of claim 15 and further comprising:
openings between the woven heating cables allowing water and debris to travel from the top surface in a general direction toward the bottom surface.

20. The snow melting apparatus of claim 15 and further comprising:
multiple covering mats wired together.
